(19) United States
(12) Patent Application Publication
(10) Pub. No.: US 2005/0102171 A1
(43) Pub. Date: May 12, 2005

(54) Elderly assessment protocol

(76) Inventors: Thomas R. Ashley, Stamford, CT (US); Anthony J. Forte, Fairfield, CT (US); James M. Greenwood, Fairfield, CT (US)

Correspondence Address: Robert E. Canuscio;DRINKER BIDDLE & REATH LLP, One Logan Square, 18th & Cherry Streets, Philadelphia, PA, 19103-6996, US

(21) Appl. No.: 10/968,794

(22) Filed: Oct. 19, 2004

Related U.S. Application Data
(60) Provisional application No. 60/515,951, filed on Oct. 29, 2003.

(51) Int. Cl. G06F 17/60

(52) U.S. Cl. 705/4

(57) ABSTRACT

Methods of classifying risk and adjusting policy pricing for elderly insurance applicants are provided. The methods preferably include the steps of requesting the applicant to perform tests in addition to a physical examination, analyzing the results of the tests, and classifying the risk of mortality of the applicant based on the results of the analysis. The additional test is preferably designed to analyze the applicant's physical performance, cognitive performance, executive function, and present physical health of an applicant.

### RELATED APPLICATION

This application is related to and claims priority from U.S. Provisional Application No. 60/515,951, filed Oct. 29, 2003, the disclosure of which is incorporated herein by reference in its entirety.

### FIELD OF THE INVENTION

The invention relates to the field of life insurance and more specifically to a method for evaluating mortality risk in elderly applicants for mortality risk-based products such as life insurance and annuities.

### BACKGROUND OF THE INVENTION

Assessing the mortality risk of an elderly (i.e., someone aged 70 or higher) applicant for a mortality risk-based product is a complex process. Generally, an elderly applicant is required to have a physical examination that is administered by a physician or paramedical examiner. The applicant is often also required to submit to urine and blood tests and ECG. The results of these tests are used to classify the applicant in a predetermined risk category. The premium (i.e., price) of the product is adjusted based on the risk classification. A substantial quantity of clinical literature relates to factors that affect mortality rates of the elderly. However, the typical risk classification scheme of an insurance company does not account for these various factors.

As such, many existing risk assessment processes are not as accurate as they can be. A need, therefore, exists for an improved risk assessment system that takes into account numerous mortality indicators.

### SUMMARY OF THE INVENTION

In one aspect, the invention is directed to a method of assessing an applicant for a mortality risk-based product. The method includes the steps of requesting the applicant to perform at least one test in addition to or in place of a physical examination, urine test or blood test, analyzing a result of all of the tests and to generate a cumulative result, and classifying the applicant into a risk category based on the cumulative result.

The test can be selected from the group that includes a physical performance test, a cognitive performance test, and an executive function test. The physical performance test can be a repeated chair raise test, a hand grip test, or a step in place test. The cognitive performance test can be a delayed word recall test. The executive performance test can be a plurality of questions worded to illustrate the degree of independent function exercised by the applicant for a specific time period.

The present invention has particular use in pricing a mortality risk-based product. The method includes the steps of requesting information related to physical capability, cognitive performance, executive function, and present physical health of an applicant, analyzing the requested information, classifying the risk of mortality of the applicant in response to the analysis step, and pricing the insurance policy for the applicant in response to the classifying step. The information related to the present physical health of an applicant can include the results of a review of medical records, electrocardiogram, hematological evaluation and a urine analysis.

These and other aspects of the invention are described in more detail below.

### BRIEF DESCRIPTION OF THE DRAWINGS

For the purpose of illustrating the invention, there is shown in the drawings a form which is presently preferred; it being understood, however, that this invention is not limited to the precise arrangements and instrumentalities shown. The drawings are not necessarily to scale, emphasis instead being placed on illustrating the principles of the present invention.

FIG. 1 is a flow chart depicting a method of the present invention.

FIG. 2 is a flow chart depicting a method of the present invention

### DETAILED DESCRIPTION OF THE PREFERRED EMBODIMENTS

Referring now to the drawings, wherein like numerals indicate like elements, there is shown various method steps of the present invention.

In one embodiment, the present invention includes a plurality of physical and mental tests that are required of an insurance applicant in addition to the standard physical exam, urine test and blood test. These tests are typically directed to different specific areas such as physical performance, cognitive performance, and executive function. The results of each of these additional testing areas are combined with the results of the physical examination and blood test to classify an applicant for insurance into a risk category of an insurance product. The different categories affect the premium price paid for the insurance product. In one embodiment, the present invention is used to assess risk associated with elderly applicants for mortality risk-based products (i.e., that is applicants 70 years old and older).

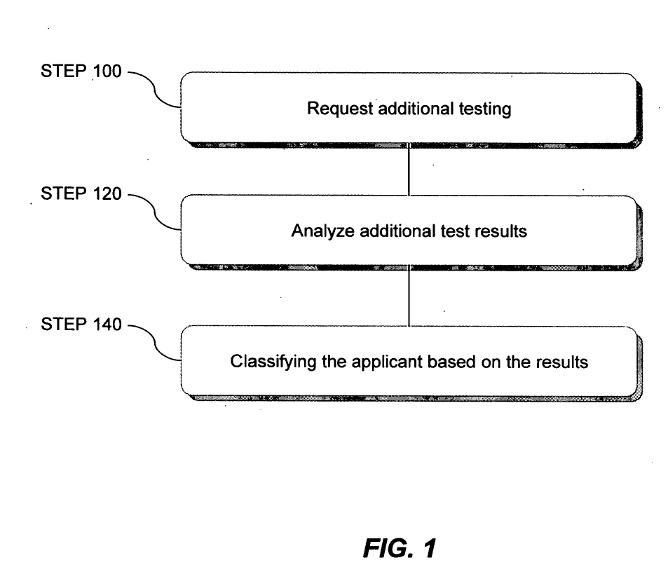

With reference to FIG. 1, in one aspect the invention is related to a method of assessing an elderly applicant for mortality risk-based products. Each applicant is requested to complete at least one test in addition to the standard physical examination urine test and blood test (STEP 100). In one embodiment, the additional test is either a physical performance test, a cognitive performance test, or an executive function test. Any combination of these tests can also be requested, as well several different tests in any particular category. In a preferred embodiment, each applicant is requested to complete at least one test in each additional category of testing (i.e., physical performance test, a cognitive performance test, or and executive function test.

The first category of testing is the physical performance test. The test provides an indication of the applicant's physical condition and the presence of frailty. One goal of the protocol is to use instruments that can be applied universally and safely. The step in place test is one such test that has universal application. Another goal is to provide a protocol that a paramedical examiner can administer in an individual's home with minimal specialized equipment, and is easily portable. The preferred performance tests that are used are those that have been validated through clinical research. Frailty and physical activity bear upon an individual's mortality risk. Frailty of an individual is a composite that includes strength and muscle mass.

The physical performance test can include at least one of a chair rise test or a step in place test. The results of each of these tests have been suggested to have a link to the mortality rate of elderly individuals. The chair rise test and it's relationship to mortality is described in more detail in Guralnik J M, Simonsick E M, Ferrucci L, et al., “A short physical performance battery assessing lower extremity function: association with self-reported disability and prediction of mortality and nursing home admission,” J. Gerontol. Med. Sci., 1994, 49(2): M85-94; Rikli R, Jones C J., “Development and validation of a functional fitness test for community-residing older adults,” J. Aging Phys. Activity, 1999, 7: 129-61; and Rikli R, Jones C J, “Functional fitness normative scores for community-residing older adults, ages 60-94,” J. Aging Phys. Activity, 1999, 7: 162-81, which are all incorporated herein by reference in their entirety. Generally the repeated chair rise involves measuring the number of times an applicant completes the chair rise in 30 seconds. The test involves standing up from a seated position in a chair and sitting back down on the chair repeatedly. The results of the test are recorded for further analysis. Previously, the results of this type of test have been used to gauge frailty in a clinical context. However, the results of the chair rise test have not been applied to assessment for mortality risk-based products. The chair rise test provides an indication of lower body integrity which, in turn, is a major factor in functional mobility and correlates with the onset of disability. Thus, the chair rise test can be used as an indicator of potential disabilities associated with mortality.

The hand grip test and it's relationship to mortality is described in more detail in Snih S A, Markides K S, Ray L, et al., “Handgrip strength and mortality in older Mexican Americans,” J. Am. Geriatr. Soc., 2002, 50: 1250-1256, which is incorporated herein by reference in its entirety. Generally, the hand grip test involves a functional assessment of an applicant's grip strength using a hand-held dynamometer. An applicant is asked to grip the dynamometer a specific number of times (e.g. 3). The results of test are recorded. The best result or average of the results can be used to assess the applicant. As noted in the above article, decreased muscle strength is related to functional limitations and disabilities. The grip strength test is used as an indicator of an applicant's muscle strength and, thus an indicator of a disability associated with an applicant's mortality.

The step in place test is described in more detail in Rikli R, Jones C J, “Development and validation of a functional fitness test for community-residing older adults,” J. Aging Phys. Activity, 1999, 7: 129-61 and Rikli R, Jones C J., “Functional fitness normative scores for community-residing older adults, ages 60-94,” J. Aging Phys. Activity, 1999, 7: 162-81, which are incorporated herein by reference in their entirety. Generally the step in place test involves measuring the number of times an applicant can raise his legs to a height midway between the iliac crest (hip) and the middle of the knee in a specific time period (e.g., 120 seconds). The results of this step are also recorded for further analysis. The step in place test provides an indication of an applicant's strength and speed, both elements of the syndrome of frailty (as does the chair rise test). By correlating the data with an applicant's age, it can be used as an indicator of an applicant's mortality.

Each of the individual physical performance test results can be used as a factor in assessing risk. Alternatively, the results of each test are weighted according to their overall effect on mortality. The weighted results are combined to generate an overall physical performance result, which is used in conjunction with the other test results to classify the applicant into a preferred risk category.

The second category of testing is cognitive performance. Cognitive performance provides an indication of an applicant's intellectual function. A test of cognitive function detects the presence of disease of the brain (e.g., dementia, mild cognitive impairment), which correlates with mortality. The Cardiovascular Health Study, among others, demonstrated that cognitive function predicts mortality. (See, Fried L P, Kronmal R A, Newman A B, et al., “Risk factors for 5-year mortality in older adults: the Cardiovascular Health Study,” JAMA, 1998, 279 (8): 585-92.) Research performed by Gen Re LifeHealth corroborates this observation specifically for the delayed word recall test. Thus, one example of how to measure the cognitive performance of an applicant is the delayed word recall test. The details of this test and it's correlation to mortality is well known to those having ordinary skill in the art in addition to the information described in Knopman D S, Ryberg S, “A verbal memory test with high predictive accuracy for dementia of the Alzheimer type,” Arch. Neurol., 1989, 46: 141-145, which is incorporated herein by reference in its entirety. Generally, the test involves showing an applicant a list of a predetermined number of words (e.g., 10) and then asking the applicant at a later time to remember what words were a part of the list. The number of words correctly remembered is recorded. The test provides an indication of the applicant's cognitive performance with respect to short term memory and can be used as factor in assessing the applicant's level of mortality.

While the delayed word recall test is the preferred test for use in the present invention, other conventional tests providing an indication of the cognitive condition of the applicant may be used. The results of the cognitive performance are used, either directly or as a weighted function, with the physical performance results and the physical examination and results of the blood work.

The third category for testing is the executive function test. The executive function test is designed to screen for geriatric syndromes such as falls or frailty or other health risks, and to measure social function. One preferred example of a suitable executive function test is a preset questionnaire that is designed to gauge the amount of independent function exhibited by an applicant for a specific time period. For example, the time period can be daily, weekly, or monthly. Some examples of questions that can be used in this test include the following:
Describe your activities of a typical week;
Are you currently employed-on a full or part time basis? If so, please describe duties and hours worked per week;
Do you engage in any hobbies, or volunteer activities on a regular basis, for example, Clubs, Church, and Organizations, Recreational activities? (Please provide details.);
During your lifetime how many years have you used tobacco in any form? On average, what is (was) your daily use of tobacco;
Do you drive? (Details of frequency and average miles driven per day.);
During the past 18 months have you fallen all the way to the ground? If yes, what were the circumstances;
What was your weight one year ago? Describe the reasons for any changes; and
Describe the details of the last time you traveled outside your immediate vicinity. (Include dates, destination, duration, and, method of travel.)

The answers to these questions provide an indication of the independence of the applicant. An applicant exhibiting a greater degree of self-care and self-control has a greater likelihood of receiving a preferred risk classification and therefore a lower premium rate.

Each of the test results is analyzed (STEP 120). The results of each of these additional individual test areas can be used to assist in classifying the applicant into one of several risk categories. Alternatively, a selected sub-set of the tests and/or categories of testing can be used. For example, only the physical performance test results and cognitive performance results may be used. However, it is preferable that all the tests and/or categories be used to provide the most accurate assessment for classifying the applicant.

The physical examination of the applicant often involves inspecting different aspects of an applicant's present physical health. Certain aspects of an applicant's present physical condition can be correlated to mortality. For example, an applicant's body mass index (BMI) and blood pressure can be used to adjust a predicted mortality of an applicant. A physical examination and blood test conducted in accordance with the principals of the present invention can include a BMI measurement, both systolic and diastolic blood pressure measurements, a peak flow breathing test measurement, an albumin level measurement, a C-reactive protein (CRP) level measurement, and high density lipoprotein cholesterol (HDLc) level measurement. Additional tests and factors can be considered. For example an ECG test can be conducted. Additional hematological data related to glucose, kidney function, and lipid panel can also be used. Further, a urine analysis can be performed to determine the microalbumin/creatinine ratio. All these factors can be combined to create a general present physical assessment of the applicant.

The relationship each one of the above noted tests has on mortality specifically in elderly persons is known to those skilled in the art. More particularly, Calle E E, Thun M J, Petrelli J M, et al., “Body-mass index and mortality in a prospective cohort of U.S. adults,” N. Engl. J. Med., 1999, 341 (15): 1097-105 and Dieher P, Bild D E, Harris T B, et al., “Body mass index and mortality in nonsmoking older adults: The Cardiovascular Health Study,” Am. J. Public Health, 1989, 88: 623-629 provide information related to BMI and are both incorporated herein by reference in their entireties. Also, Glynn R J, Field T S, Rosner B, et al., “Evidence for a positive linear relation between blood pressure and mortality in elderly people,” Lancet, 1995, 345 (8953): 825-9 and Psaty B M, Furberg C D, Kuller L H, et al., “Association between blood pressure level and the risk of myocardial infarction, stroke, and total mortality,” Arch. Intern. Med., 2001, 161: 1183-1192, provide information related to blood pressure and are both incorporated herein by reference in their entireties. Furthermore, Cook N R, Evans D A, Scherr P A, et al., “Peak expiratory flow rate and 5-year mortality in an elderly population,” Am J Epidemiol, 1991, 133: 784-93 provides information related to the peak flow breath test, and is incorporated herein by reference in its entirety. Corti M C, Guralnik J M, Salive M E, Sorkin J D, “Serum albumin level and physical disability as predictors of mortality in older persons,” JAMA, 1994, 272 (13): 1036-42, Reuben D B, Ferrucci L, Wallace R, et al., “The prognostic value of serum albumin in healthy older persons with low and high serum IL-6 levels,” J. Am. Geriatr. Soc., 2000, 48: 1404-1407, and Fried L P, Kronmal R A, Newman A B, et al., “Risk factors for 5-year mortality in older adults: the Cardiovascular Health Study,” JAMA, 1998, 279 (8): 585-92 provide information related to albumin, and are each incorporated herein by reference in its entirety. Harris T B, Ferrucci L, Tracy R P, et al., “Associations of elevated interleukin-6 and c-reactive protein levels with mortality in the elderly,” Am. J. Med., 1999, 106: 506-512 and Reuben D B, Cheh A I, Harris T B, et al., “Peripheral blood markers of inflammation predict mortality and functional decline among high functioning community-dwelling older persons,” J. Am. Geriatr. Soc., 2002, 50: 638-644 provide information related to CRP, and are each incorporated herein by reference in its entirety. Lastly, Corti M C, Guralnik J M, Salive M E, et al., “HDL cholesterol predicts coronary heart disease mortality in older persons,” JAMA, 1995, 274: 539-544, Corti M C, Guralnik J M, Salive M E, et al., “Clarifying the direction relation between total cholesterol levels and death from coronary heart disease in older persons,” Ann. Intern. Med., 1997, 126: 753-760, and Fried L P, Kronmal R A, Newman A B, et al., “Risk factors for 5-year mortality in older adults: the Cardiovascular Health Study,” JAMA, 1998, 279 (8): 585-92 provide information related to HDLc, and are each incorporated herein by reference in its entirety.

After the results have been analyzed, the applicant is classified according to the results of the analysis (STEP 140). An example of how the results of the tests described above can be used to assign an applicant to a particular risk category is described in the following table:

| | Preferred | Standard | Substandard | Uninsurable |
|---|---|---|---|---|
| Relative | <0.9 | 0.9-1.5 | 1.5-3 | >3 |
| mortality risk | | | | |
| Hand grip (kg) | >35/>22 | 30-35/18-22 | 20-30/12-18 | <20/<12 |
| Chair rise | >11 | 8-11 | 5-7 | <4 |
| Step test | >70 | 50-70 | 30-50 | <30 |
| DWR | >5 | 4-5 | 2-3 | 0-1 |
| BMI | 22-29 | 19-22; 30-35 | <19; >35 | |
| SBP | 105-140 | 140-160 | 160-175 | >175 |
| DBP | 60-80 | 81-90 | 81-90 | 81-90 |
| Pulse pressure | | <70 | <75 | >75 |
| Peak flow | >240 | 180-2400 | 150-180 | <150 |
| Albumin | >4.3 | 3.6-4.3 | 3-3.6 | <3 |
| CRP | <2 | 2-5 | 5-7 | >7 |
| HDLC | >45 | 35-45 | 30-35 | <30 |

In one embodiment, each category of the above table is given equal weight. In other words, in order to qualify in the preferred category, an applicant must meet the criteria for each test in that preferred column. For example, if the applicant were only able to recall 5 words during the delayed word recall (DWR) test, the applicant would not qualify for the preferred status.

In an alternate embodiment, certain categories are given a greater weight (i.e., influence) on the overall classification of the applicant. For example, if blood pressure and build are in the standard category range, the applicant may receive a preferred classification if the step test result is greater than 120 and DWR test result is great than 8. In this embodiment, the weight given to each category would be determined based on analysis of clinical research, adjusted as insurance experience accumulates.

In construction of a weighted formula, the relative importance and result of each factor would be assessed based on experience and judgment of the factors used. The goal is to subdivide the applicant pool into a desired number of groups, of a desired size for each group, for example, 30% preferred, 40% standard, 20% substandard, 10% uninsurable, and a desired mortality rate. A pilot study can be used to obtain initial evidence of the distribution of values in the applicant pool.

As more data is acquired, the cut points and weights of each factor can be adjusted. It is contemplated that there may be some differences in cut points based on age.

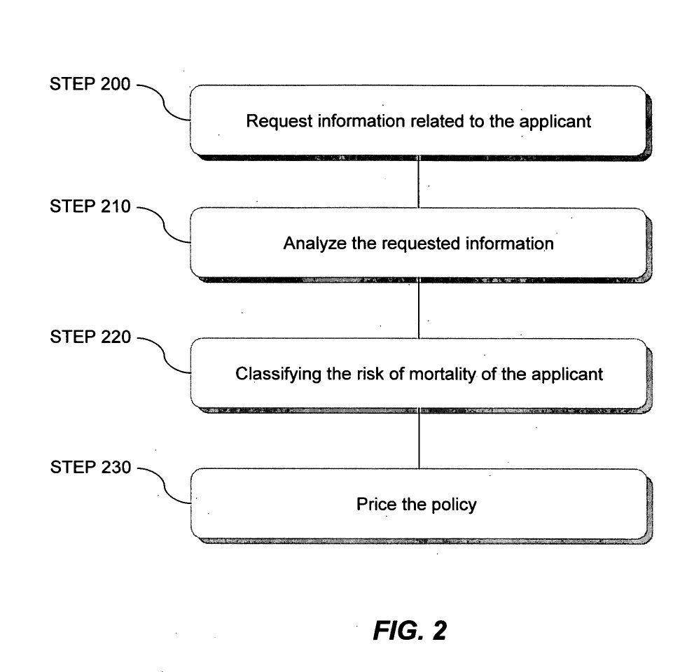

With reference to FIG. 2, the present invention is particularly useful as a method of pricing mortality risk-based products. In addition to the standard physical typically required by an insurance company, the applicant is requested to perform at least one additional test (and more preferably several of the additional test categories) described above (STEP 200). The results of the test are analyzed (STEP 210). In response to the analysis, the mortality of each applicant is classified (STEP 220). The price of the policy is adjusted according to the result of the classification (STEP 230). For example, the preferred premium for a $100,000 policy may be $500 dollars a month for a 70-year-old male applicant who meets all the standard criteria. However, if the applicant is only able to recall 5 words during the delayed recall test, the premium is adjusted to the substandard level. For example, the premium can increase to $700 per month.

Although the invention has been described as being useful for life insurance, the teachings herein can also be used to evaluate and classify applicants for a variety of insurance policies, such as annuities, automobile insurance, disability insurance, critical illness insurance, long term care insurance, and health insurance.

It should be understood that the present invention can be embodied in various forms. For example, the invention can be a software system that is programmed in any number of different languages such as C++ and Java. The software system can be an internet based application or stored in a computer readable medium such as a CD-ROM. Alternatively, the invention can be embodied as various hardware components that perform the functionality herein described.

As noted above, a variety of modifications to the embodiments described will be apparent to those skilled in the art from the disclosure provided herein. Thus, the present invention may be embodied in other specific forms without departing from the spirit or essential attributes thereof and, accordingly, reference should be made to the appended claims, rather than to the foregoing specification, as indicating the scope of the invention.

1. A method of assessing an applicant for mortality risk-based products comprising the steps of:
requesting the applicant perform at least one test in addition to a physical examination;
analyzing a result of the at least one test and the physical examination to generate a cumulative result: and
classifying the applicant into a risk category based on the cumulative result.

2. The method of claim 1 wherein the at least one test is selected from the group consisting of a physical performance test, a cognitive performance test, and an executive function test.

3. The method of claim 2 wherein the physical performance test comprises a repeated chair rise test.

4. The method of claim 2 wherein the physical performance test comprises a hand grip test.

5. The method of claim 2 wherein the physical performance test comprises a step in place test.

6. The method of claim 2 wherein the cognitive performance test comprises a delayed word recall test.

7. The method of claim 2 wherein the executive performance test comprises a plurality of questions worded to illustrate the degree of independence exercised by the applicant for a specific time period.

8. The method of claim 7 wherein the time period is selected from the group consisting of daily, monthly, and yearly.

9. A method for pricing mortality risk-based products comprising the steps of:
requesting information related to physical capability, cognitive performance, executive function, and present physical health of an applicant;
analyzing the requested information;
classifying the risk of mortality of the applicant in response to the analysis step; and
pricing the mortality risk-based product for the applicant in response to the classifying step.

10. The method of claim 9 wherein the information related physical capability comprises a result from at least one test selected from the group consisting of a repeated chair raise test, a hand grip test, and a step in place test.

11. The method of claim 9 wherein the information related to cognitive performance comprises a result from a delayed word recall test.

12. The method of claim 9 wherein the information related to executive function comprises a plurality of answers to a plurality of questions worded to illustrate the degree of independence exercised by the applicant for a specific time period.

13. The method of claim 9 wherein the information related to the present physical health of an applicant comprises a result of a hematological evaluation.

14. The method of claim 9 wherein the information related to the present physical health of an applicant comprises a results of a urine analysis.

15. A method of assessing an applicant for mortality risk-based products comprising the steps of:
receiving information related to an applicant's current physical health and the results of testing of at least one of the applicant's physical performance, cognitive performance, executive function;
analyzing the received information by comparison of at least the testing against known values for determining cumulative mortality result: and
classifying the applicant into a risk category for a mortality risk-based product based on the cumulative result.

16. The method of claim 15 wherein the physical performance test comprises a repeated chair rise test.

17. The method of claim 15 wherein the physical performance test comprises a hand grip test.

18. The method of claim 15 wherein the physical performance test comprises a step in place test.

19. The method of claim 15 wherein the testing involves at least both the physical performance test and the cognitive performance test, wherein the physical performance test involves conducting several different tests on the applicant to assess the applicant's physical condition, each test having a correlation with mortality, and wherein the cognitive performance test involves at least one test assessing an applicant's short term memory.

20. The method of claim 15 wherein the cognitive performance test comprises a delayed word recall test.

21. The method of claim 15 wherein the executive performance test comprises a plurality of questions worded to illustrate the degree of independence exercised by the applicant for a specific time period.

22. The method of claim 15 wherein the step of analyzing the received information involves applying a weighted factor against at least some of the test results, the weighted factor being based on the correlation of the test with mortality.

23. The method of claim 15 wherein the risk based mortality product is an insurance policy and wherein the risk categories are used for determining a price for an insurance policy for the applicant.
